(19) United States
(12) Patent Application Publication
(10) Pub. No.: US 2003/0095105 A1
(43) Pub. Date: May 22, 2003

(54) Extended keyboard

(76) Inventor: Johannes Vaananen, Oulu (FI)

Correspondence Address: Lance J Lieberman, Cohen Pontani Lieberman & Pavane, Suite 1210, 551 Fifth Avenue, New York, NY, 10176, US

(21) Appl. No.: 10/049,314

(22) PCT Filed: Nov. 16, 2001
(86) PCT No.: PCT/FI01/01001

(51) Int. Cl. G09G 5/00

(52) U.S. Cl. 345/168

(57) ABSTRACT

The present invention describes a method and an electronic device where an alphanumeric keyboard is presented with the device. The alphanumeric keyboard is divided between the touch screen and touch-sensitive cover of the electronic device.

The division is done so that the alphanumeric keyboard is divided into two or more parts. The aim of the division is that the size of the alphanumeric keyboard would be sufficient for easy inputting of alphanumeric characters. One part of the alphanumeric keyboard is presented on the touch screen of the electronic device. The other parts of the alphanumeric keyboard are placed on the touch-sensitive cover of the electronic device outside the touch screen. The keyboard set on the touch screen can be changed so that a different set of characters, e.g. numeric characters are shown on the touch screen.

### FIELD OF THE INVENTION

The present invention relates to electronic devices. In particular, the present invention relates to a novel and improved method for presenting an alphanumeric keyboard with an electronic device.

### BACKGROUND OF THE INVENTION

In information technology, the user interface (UI) is everything designed into an information device with which a human being may interact, including display screen, keyboard, mouse, light pen, the appearance of a desktop, illuminated characters, help messages, and how an application program or a Web site invites interaction and responds to it.

Personal Digital Assistants (PDA) or other hand-held electronic devices typically comprise a large display area in proportion to the size of the device. Most PDAs include only a few mechanical buttons in order to provide as large display area as possible. Therefore, the display area is also used as an input device. The display area is usually a touch screen so that information can be transferred into the device just by touching the display or using a special tool, e.g. a special pen.

A touch screen is a display screen that is sensitive to human touch, allowing a user to interact with the device by touching pictures or words on the screen. Touch screen technology can be used as an alternative user interface with applications that normally require a mouse, such as a Web browser. Some applications are designed specifically for touch screen technology, often having larger icons and links than the typical, e.g. PC application. There are basically three types of touch screen technology:

Resistive: A resistive touch screen panel is coated with a thin metallic electrically conductive and resistive layer that causes a change in the electrical current which is registered as a touch event and sent to the controller for processing.

Surface wave: Surface wave technology uses ultrasonic waves that pass over the touch screen panel. When the panel is touched, a portion of the wave is absorbed. This change in the ultrasonic waves registers the position of the touch event and sends this information to the controller for processing.

Capacitive: A capacitive touch screen panel is coated with a material that stores electrical charges. When the panel is touched, a small amount of charge is drawn to the point of contact. Circuits located at each corner of the panel measure the charge and send the information to the controller for processing. Capacitive touch screen panels must be touched with a finger unlike resistive and surface wave panels that can use fingers and stylus.

A touch screen can also be a touch-sensitive panel. U.S. Pat. No. 5,241,308 (Paragon Systems) describes a touch-sensitive panel for generating selected ones of any of a plurality of different signals, each of which is generated by touching a different location on the panel. The apparatus includes also force sensing means for sensing the magnitudes of the forces that are applied to each panel member support by the panel member when the member is touched at a selected location.

The user of an electronic device can be provided with various feedback signals. One form of feedback is haptic feedback. The reference publication WO01/54109 (Immersion) represents a solution of haptic feedback for touchpads and other touch controls. In the publication, a user uses a touch-input device for entering control instructions. Moreover, at least one actuator is coupled to the touch-input device and outputs a force to provide a haptic sensation to the user contacting the touch surface. In other words, the user receives feedback from the input device itself. The actuator is situated under the touch-sensitive display.

The problem is how to represent an alphanumeric keyboard with an electronic device of a limited size. Most touch screen devices represent the keyboard on the display one way or another. If the whole keyboard in essence is displayed with the device, the size of individual characters to be pressed is very small. Another way is to reorganise the keyboard, e.g. a QWERTY keyboard, and display it completely or partly at a time. However, the latter solution has the disadvantage that the familiar character pattern is broken down.

Another solution is to form a keyboard, e.g. QWERTY keyboard, completely outside the display area, e.g. as in Nokia 9210 Communicator. This, however, significantly increases the size of the device and, above all, decreases the size of an individual key.

The reference publication WO 94/22069 (Dynapro Technologies Inc.) represents a solution which enables the touch screen to be extended beyond the area of the display over which the touch screen is mounted. Touch-sensitive regions can thus be provided outside the display area. The purpose of the reference publication is to maximise the display area remaining for the output function. U.S. Pat. No. 4,827,410 (Corren) represents a similar solution where regions outside the display are used as input means.

### SUMMARY OF THE INVENTION

The present invention describes a method and an electronic device where an alphanumeric keyboard is presented with the device. The alphanumeric keyboard is divided between the touch screen and touch-sensitive cover of the electronic device.

The division is done so that the alphanumeric keyboard is divided into two or more parts. The aim of the division is that the size of the alphanumeric keyboard would be sufficient for easy inputting of alphanumeric characters. One part of the alphanumeric keyboard is presented on the touch screen of the electronic device. The other parts of the alphanumeric keyboard are placed on the touch-sensitive cover of the electronic device outside the touch screen. The keyboard set on the touch screen can be changed so that a different set of characters, e.g. numeric characters are shown on the touch screen.

In one embodiment, the touch screen and the touch-sensitive cover features are enabled with an at least partially transparent touch-sensitive panel covering the actual display.

In one embodiment, the user of the electronic device is provided with haptic feedback.

The present invention has several advantages over the prior-art solutions. An alphanumeric keyboard is divided between the touch-sensitive cover and the touch screen so that the size of individual characters is sufficient. Thus, this enables easy inputting with a traditional QWERTY keyboard set.

A further advantage of the present invention is that characters on the touch-sensitive cover and on the touch screen are on their same familiar places as in the traditional QWERTY keyboard set. This in turn enables faster inputting of characters.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a preferred embodiment of the electronic device in accordance with the present invention, and

FIG. 2 is a block diagram illustrating one embodiment of the electronic device of the present invention.

### DETAILED DESCRIPTION OF THE INVENTION

Reference will now be made in detail to the embodiments of the present invention, examples of which are illustrated in the accompanying drawings.

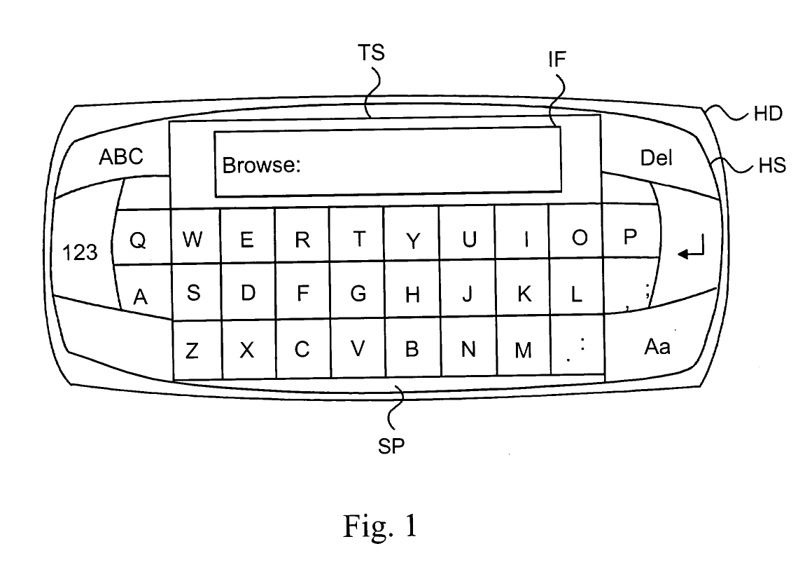

FIG. 1 represents a preferred embodiment of the electronic device of the present invention. FIG. 1 describes a hand-held electronic device HD. FIG. 1 is a simplified example of the device so that only relevant parts and features are represented relating to the present invention. The hand-held device HD comprises a touch screen TS and a touch-sensitive cover area HS surrounding the touch screen TS. In one embodiment, the touch screen and the touch-sensitive cover features are enabled with a touch-sensitive panel. Thus, the front cover of the hand-held device consists of the touch-sensitive panel mounted in front of the actual display. There are, e.g. force sensors coupled to the panel, thus yielding the touch-sensitive feature.

The alphanumeric keyboard set is in essence presented with the hand-held device. The alphanumeric keyboard is divided into two or more parts. The major part, not the entire keyboard, is shown on the touch screen TS. The other parts are placed in the touch-sensitive cover HS. For example, characters “Q”, “A”, “P” as well as “,” are placed on the touch-sensitive cover HS. There characters form a natural extension to the characters shown on the touch screen TS. There are also other characters on their familiar places: Delete (Del), return ( [symbol] ), shift (Aa) and space bar SP. By pressing the key “123” it is possible to change the layout on the touch screen TS. When “123” is pressed, numbers and/or special characters appear on the touch screen TS. By pressing the key “ABC” it is possible to change the layout on the touch screen TS back to the alphanumeric keyboard. FIG. 1 comprises also a portion of the touch screen TS where input characters are shown. In one embodiment of FIG. 1, some or all of the alphanumeric keyboard part(s) outside the touch screen TS are mechanical keys. Therefore, the term touch-sensitive cover can at least partly refer to mechanical keyboard parts.

In a preferred embodiment, there is also an input area IF on the touch screen TS. The operating system of the electronic device preferably keeps the input area IF in the area of the touch screen TS that is outside the alphanumeric keyboard. The operating system of the electronic device may also comprise such a feature that when alphanumeric input is needed, the alphanumeric keyboard is automatically activated, and the operating system places the input area IF in the area of the touch screen TS that is outside the alphanumeric keyboard.

FIG. 1 represents only one embodiment of the solution of the present invention. The keys of the alphanumeric keyboard do not have to be laid out in a form of a regular grid. The layout can also be like in a mechanical QWERTY keyboard where the left side of a key below is not aligned with the left side of the key above.

In one embodiment of FIG. 1 the alphanumeric keyboard on the touch screen TS is essentially visible. When, e.g. a web page is displayed on the touch screen TS and the user of the electronic device wants to input text into an input field, the alphanumeric keyboard is automatically activated by the operating system. However, the alphanumeric keyboard on the touch screen TS is placed on the web page so that they are overlapping. Both the web page and the alphanumeric keyboard can be distinguished at the same time.

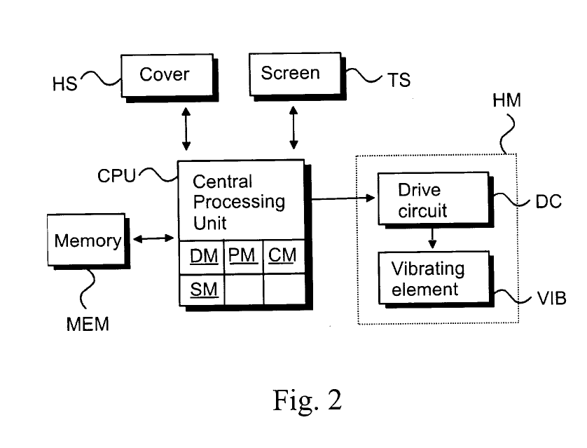

FIG. 2 is a block diagram illustrating one embodiment of the electronic device of the present invention. FIG. 2 represents only relevant parts of the electronic device. The electronic device comprises a central processing unit CPU that controls the device. The memory MEM is associated with the CPU. Also the touch-sensitive cover HS and touch screen TS are associated with the CPU. In one embodiment, the touch screen and the touch-sensitive cover features are enabled with a touch-sensitive panel. Thus, the front cover of the hand-held device consists of a touch-sensitive panel mounted in front of the actual display. There are, e.g. force sensors coupled to the panel, thus yielding the touch-sensitive feature.

The central processing unit CPU comprises means for dividing DM the alphanumeric keyboard into two or more parts, means for presenting PM one part of the alphanumeric keyboard on the touch screen TS, means for displaying SM said part of the alphanumeric keyboard on the touch screen TS as overlapping the other content on the touch screen TS, and means for changing CM the keyboard set on the touch screen TS. These means are preferably implemented with various software components with the aid of the memory MEM. In one embodiment, the electronic device comprises also means for generating HM haptic feedback. Means for generating HM haptic feedback consists of a drive circuit DC supplying a drive signal to a vibrating element VIB. The vibrating element is, e.g. a piezo-bender.

In the present invention, part of the keyboard is soft (on the display) and part of it is preferably painted on the touch-sensitive cover area outside the touch screen. When the keyboard is launched, the soft part on the touch screen melts without significant borders into the painted part(s) of the keyboard on the touch-sensitive cover.

The advantage of this invention is that a larger keyboard is easier to use. The present invention enables also the possibility of multiple layouts by painting the touch-sensitive cover area with more than one scheme and further by illuminating different schemes of the touch-sensitive cover area separately. The present invention can be used in all compact devices with screen and the necessity to implement a keypad (keyboard). These devices include, e.g. mobile terminals, mobile phones, PDAs, gaming consoles, automotive small informative displays with large side area, etc.

It is obvious to a person skilled in the art that with the advancement of technology, the basic idea of the invention may be implemented in various ways. The invention and its embodiments are thus not limited to the examples described above, instead they may vary within the scope of the claims.

1. A method for presenting an alphanumeric keyboard with an electronic device comprising at least a touch screen and a touch-sensitive cover, wherein the method comprises the steps of:
dividing the alphanumeric keyboard into two or more parts;
presenting one part of the alphanumeric keyboard on the touch screen of the electronic device; and
placing the other part(s) of the alphanumeric keyboard on the touch-sensitive cover of the electronic device outside the touch screen.

2. The method according to claim 1, wherein changing the keyboard set on the touch screen.

3. The method according to claim 1, wherein enabling said touch screen and said touch-sensitive cover features with an at least partially transparent touch-sensitive panel.

4. The method according to claim 1, wherein providing haptic feedback with the electronic device.

5. The method according to claim 1, wherein some or all of said other parts(s) of the alphanumeric keyboard comprise mechanical key(s).

6. An electronic device for presenting an alphanumeric keyboard, the electronic device comprising:
a touch screen (TS);
a touch-sensitive cover (HS);
software components operating the electronic device;
means for dividing (DM) the alphanumeric keyboard into two or more parts;
means for presenting (PM) one part of the alphanumeric keyboard on the touch screen (TS); and
one or more alphanumeric keyboard parts on the touch-sensitive cover (HS) of the electronic device outside the touch screen (TS) area.

7. The electronic device according to claim 6, wherein the electronic device comprises means for changing (CM) the keyboard set on the touch screen (TS).

8. The electronic device according to claim 6, wherein the electronic device comprises an at least partially transparent touch-sensitive panel enabling said touch screen and said touch-sensitive cover features.

9. The electronic device according to claim 6, wherein the electronic device comprises means for generating (HM) haptic feedback.

10. The electronic device according to claim 6, wherein some or all of said other parts(s) of the alphanumeric keyboard comprise mechanical key(s).
